(19) United States
(12) Patent Application Publication
(10) Pub. No.: US 2002/0042704 A1
(43) Pub. Date: Apr. 11, 2002

(54) Apparatus and methods for characterizing electronic circuits having multiple power supplies

(76) Inventors: Farid N. Najm, Mississauga (CA); Richard J. Shank, Buda, TX (US)

Correspondence Address: Maximilian R. Peterson, O'KEEFE, EGAN & PETERMAN, Building C, Suite 200, 1101 Capital of Texas Highway South, Austin, TX, 78746, US

(21) Appl. No.: 09/933,532

(22) Filed: Aug. 20, 2001

Related U.S. Application Data
(60) Provisional application No. 60/229,825, filed on Aug. 31, 2000.

(51) Int. Cl. G06F 17/50

(52) U.S. Cl. 703/14

(57) ABSTRACT

A system for characterizing multiple power-supply circuits includes a computer. The computer characterizes energy attributes of a circuit that includes a cell. The cell couples to a plurality of power supplies and has one or more outputs that drive, respectively, one or more loads. The computer uses a model of an operation of the circuit to characterize a dynamic energy attribute of each of the plurality of the power supplies. The computer further uses the model of the operation of the circuit to characterize a dynamic energy attribute of the one or more loads. The computer calculates calculate an overall dynamic energy attribute for the plurality of power supplies by summing together the dynamic energy attributes of the plurality of the power supplies. The computer determines an overall dynamic energy attribute for the one or more loads by adding together the dynamic energy attributes of the one or more loads. Finally, the computer obtains a dynamic energy attribute of the cell by subtracting the overall dynamic energy attribute for the one or more loads from the overall dynamic energy attribute of the plurality of power supplies.

### CROSS-REFERENCE APPLICATIONS

This patent application claims priority to U.S. Provisional Patent Application Ser. No. 60/229,825, Attorney Docket No. 027195.0005, titled “Method for Highly Accurate Black Box Power Dissipation Measurement for Characterization of Arbitrary Cells with Multiple Power Supplies,” and filed on Aug. 31, 2000. This patent application incorporates by reference the above provisional patent application.

### TECHNICAL FIELD OF THE INVENTION

This invention relates to characterizing electronic circuits and, more particularly, to characterizing power or energy attributes of electronic circuits that have multiple power supplies.

### BACKGROUND

Complexity of a typical electronic circuit, for example, an integrated-circuit device, has increased dramatically. At the same time, the length of the design cycle (i.e., the time required to complete the design) has typically remained unchanged or has become shorter. To meet the shorter design cycles for the more complex designs, circuit designers increasingly rely on simulation and characterization of the designs in order to identify any problems early in the design cycle. The short design cycles and the complexity of the integrated-circuit devices make cost- and time-prohibitive an approach that characterizes a design by actually realizing the design in hardware and testing it in a laboratory.

As an alternative to actually building a prototype of the design, circuit designers have increasingly relied on electronic design automation (EDA) tools, such as circuit simulation and characterization tools. Effective circuit simulation tools provide a way for the designer to simulate the behavior of a complex design, identify any problems, and make alterations and enhancements to the circuit before arriving at a final design. That iterative design process has in turn improved the reliability of the end-products that incorporate a given circuit design. The effectiveness of a circuit characterization or simulation tool depends on several criteria, for example, accuracy, reliability, and predictability.

Traditional approaches to characterizing or simulating various attributes of circuits, for example, intrinsic delay, output transition time, or power, sometimes fail to meet those criteria. In other words, the traditional approaches may fail to provide results that match the behavior of an actual prototype relatively closely. The failure of the traditional characterization techniques results in increased costs, longer design cycles, less reliable end-products, and/or less-than-optimal designs.

One aspect of characterizing a circuit involves characterizing energy or power attributes of a cell within a circuit that includes multiple power supplies. The energy or power flow within a multiple power-supply circuit may have several components, such as the energy delivered to the cell within the circuit, the energy delivered by the power supplies, the energy components because of circuit capacitance, and the like. Known techniques focus on estimating the power attributes of the overall circuit, rather than the power or energy attributes of the cell, which in turn involves characterizing the power and energy attributes of the interconnect capacitance, output capacitance, and the like. A need therefore exists for techniques and tools for characterizing the power and/or energy attributes of a cell within a circuit that has multiple power supplies.

### SUMMARY OF THE INVENTION

The invention contemplates characterizing multiple power-supply electronic circuits. One aspect of the invention relates to systems for characterizing multiple power-supply circuits. In one embodiment of the invention, a system includes a computer for characterizing energy attributes of a circuit that includes a cell. The cell couples to a plurality of power supplies and has one or more outputs that drive, respectively, one or more loads.

The computer characterizes a dynamic energy attribute of each of the plurality of the power supplies according to a model of an operation of the circuit. The computer also characterizes a dynamic energy attribute of the load(s) according to the model of the operation of the circuit. Then, the computer calculates an overall dynamic energy attribute for the plurality of power supplies by summing together their respective dynamic energy attributes. Similarly, the computer determines an overall dynamic energy attribute for the load(s) by adding together their respective dynamic energy attributes. Finally, the computer computes a dynamic energy attribute of the cell by subtracting the overall dynamic energy attribute for the load(s) from the overall dynamic energy attribute of the plurality of power supplies.

A second aspect of the invention relates to computer program products for characterization of multiple power-supply circuits. In one embodiment, a computer program product includes a computer application adapted for processing by a computer to characterize energy attributes of a circuit that includes a cell. The cell couples to a plurality of power supplies and has one or more outputs that drive, respectively, one or more loads. The computer application causes the computer to characterize a dynamic energy attribute of each of the plurality of the power supplies according to a model of an operation of the circuit. The computer application further causes the computer to characterize a dynamic energy attribute of the load(s) according to the model of the operation of the circuit.

Under the direction of the computer application, the computer calculates an overall dynamic energy attribute for the plurality of power supplies by summing together their respective dynamic energy attributes. The computer similarly determines an overall dynamic energy attribute for the load(s) by adding together their respective dynamic energy attributes. Finally, the computer application causes the computer to compute a dynamic energy attribute of the cell by subtracting the overall dynamic energy attribute for the load(s) from the overall dynamic energy attribute of the plurality of power supplies.

A third aspect of the invention concerns methods for characterizing multiple power-supply circuits. One embodiment of the invention relates to a method for characterizing a circuit that includes a cell. The cell couples to a plurality of power supplies and has one or more outputs that drive, respectively, one or more loads. The method includes characterizing a dynamic energy attribute of each of the plurality of the power supplies according to a model of an operation of the circuit. The method also includes characterizing a dynamic energy attribute of the load(s) according to the model of the operation of the circuit.

The method according to the invention calculates an overall dynamic energy attribute for the plurality of power supplies by summing together their respective dynamic energy attributes, and determines an overall dynamic energy attribute for the load(s) by adding together the dynamic energy attributes of the load(s). The method further includes computing a dynamic energy attribute of the cell by subtracting the overall dynamic energy attribute for the load(s) from the overall dynamic energy attribute of the plurality of power supplies.

### DESCRIPTION OF THE DRAWINGS

The appended drawings illustrate only exemplary embodiments of the invention and therefore should not limit its scope. The disclosed inventive concepts lend themselves to equally effective embodiments other than the exemplary embodiments shown in the drawings. The same numerals used in more than one drawing denote the same, similar, or equivalent functionality, components, or blocks, unless the description of the drawings states otherwise.

FIG. 1 illustrates a block diagram of a circuit-characterization system according to the invention.

FIG. 2 shows a block diagram of a process flow for a circuit-characterization system according to the invention.

FIG. 3 illustrates a general block diagram of a cell or circuit under test by a circuit characterization system according to the invention.

FIGS. 4A and 4B depict the conventions used for determining energy or power attributes of a circuit or cell.

FIG. 5A illustrates a block diagram of an inverter that receives an input signal and drives an output load.

FIG. 5B shows switching and short-circuit currents in a more detailed circuit schematic of the inverter of FIG. 5A.

FIG. 6A illustrates a circuit diagram of a two-input NOR gate that receives two input signals and delivers an output signal to an output load.

FIG. 6B shows a set of input waveforms and a corresponding output waveform for the two-input NOR gate of FIG. 6A that helps to illustrate hidden power or energy consumption by the two-input NOR gate.

FIG. 6C depicts a schematic diagram of the two-input NOR gate of FIG. 6A that helps to illustrate hidden power or energy consumption by the two-input NOR gate.

FIG. 7 shows a circuit that includes a cell that drives output loads, and multiple power supplies that provide power to the cell for characterization according to the invention.

FIG. 8A depicts a diagram of a multiple-supply circuit that includes two inverters that each drive a load.

FIG. 8B illustrates a more detailed schematic diagram of the circuit of FIG. 8A that includes some parasitic circuit-elements.

FIG. 9 shows a general diagram of a multiple power-supply circuit for characterization according to the invention.

FIG. 10A depicts an inverter that has an input coupled to an input source and an output that drives a capacitive load.

FIG. 10B illustrates a more detailed schematic of the circuit of FIG. 10A that includes some parasitic circuit-elements.

FIG. 10C depicts a schematic diagram of the circuit of FIG. 9B that includes lumped models of the parasitic circuit-elements for characterization according to the invention.

### DETAILED DESCRIPTION OF THE INVENTION

This invention contemplates apparatus and methods for characterizing energy consumption within electronic circuits. More particularly, the invention relates to techniques for characterizing energy or power attributes of circuits that couple to multiple power supplies.

Characterization of Electronic Circuits

Design and implementation of a modem electronic circuit typically involves characterization of the circuit. Generally, circuit or cell characterization refers to the process of determining a circuit's or cell's response to various external conditions. Put another way, characterization constitutes the acquisition of a set of measurements that predict how a real implementation (i.e., an implementation in actual hardware, for example, on an integrated circuit device) of the circuit will behave in response to a stimulus or stimuli. A given design, for example, a circuit designed for implementation on an integrated circuit device, usually includes modules or cells. Each cell or module typically constitutes a circuit that includes a collection of circuit elements, for example, transistors, diodes, resistors, and the like. One may characterize the cells in a given design to determine various cell qualities or attributes, such as timing, energy flow, and power flow.

As part of cell characterization, the characterization tool measures the responses of the cell or circuit at one or more characterization points and records those responses in the form of a characteristic equation or, alternatively, a characterization table. A characterization point refers to a set of one or more of voltage, current, temperature, and process for which the tool characterizes a cell or circuit. For a given characterization point, the tool typically measures a cell's response with respect to various input transition times and capacitive loads to determine the cell's behavior. A cell's behavior refers to the way the cell or circuit's output quantity (e.g., voltage) behaves as a function of its input stimulus or stimuli. For example, an AND gate behaves like a logical “and” operation. The behavior determines how a designer will use a cell or circuit, and what measurements a tool should take to predict how the cell or circuit will operate once physically implemented.

The type and amount of measurements a tool takes varies, usually driven by modeling considerations. The desired models for a cell or circuit determine what measurements a tool will take. Measurements may cover various quantities, for example, power and timing. Power measurements determine how much power a cell or circuit consumes as it operates. Power measurements may include leakage power, hidden power, and switching power, etc.

To generate timing models, the tool performs timing characterization of the cell or circuit. Similarly, to generate power models, the tool performs power characterization of the cell or circuit. Currently in the industry, the main model for cell characterization is Synopsys Incorporated's Liberty model. This model encompasses some aspects of timing and power. Other common models includes ALF, Verilog, VHDL, and VITAL. These models dictate what measurements the characterization tool should take and how it should acquire those measurements.

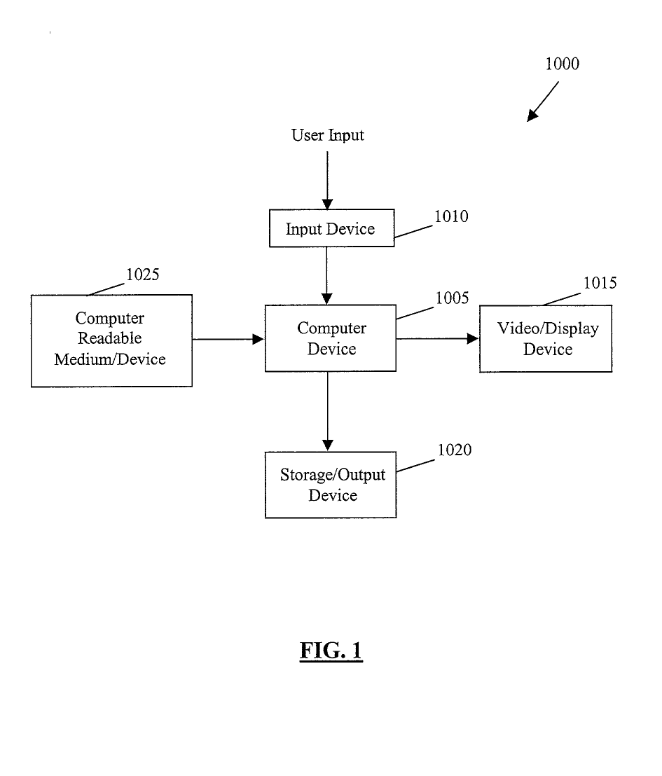

To characterize a given circuit design, one typically uses a computer system that processes information relating to that circuit. FIG. 1 shows a block diagram of a system 1000 for processing information. The system 1000 includes a computer device 1005, an input device 1010, a video/display device 1015, and a storage/output device 1020, although one may include more than one of each of those devices, as desired. The computer device 1005 couples to the input device 1010, the video/display device 1015, and the storage/output device 1020. The system 1000 may include more that one computer device 1005, for example, a set of associated computer devices or systems, as desired.

The system 1000 operates in association with input from a user. The user input typically causes the system 1000 to perform specific desired information-processing tasks, including circuit characterization and/or circuit simulation. The system 1000 in part uses the computer device 1005 to perform those tasks. The computer device 1005 includes an information-processing circuitry, such as a central-processing unit (CPU), although one may use more than one CPU or information-processing circuitry, as persons skilled in the art would understand.

The input device 1010 receives input from the user and makes that input available to the computer device 1005 for processing. The user input may include data, instructions, or both, as desired. The input device 1010 may constitute an alphanumeric input device (e.g., a keyboard), a pointing device (e.g., a mouse, roller-ball, light pen, touch-sensitive apparatus, for example, a touch-sensitive display, or tablet), or both. The user operates the alphanumeric keyboard to provide text, such as ASCII characters, to the computer device 1005. Similarly, the user operates the pointing device to provide cursor position or control information to the computer device 1005.

The video/display device 1015 displays visual images to the user. The visual images may include information about the operation of the computer device 1005, such as graphs, pictures, images, and text. The video/display device may constitute a computer monitor or display, a projection device, and the like, as persons of ordinary skill in the art would understand. If a system uses a touch-sensitive display, the display may also operate to provide user input to the computer device 1005.

The storage/output device 1020 allows the computer device 1005 to store information for additional processing or later retrieval (e.g., softcopy), to present information in various forms (e.g., hardcopy), or both. As an example, the storage/output device 1020 may constitute a magnetic, optical, or magneto-optical drive capable of storing information on a desired medium and in a desired format. As another example, the storage/output device 1020 may constitute a printer, plotter, or other output device to generate printed or plotted expressions of the information from the computer device 1005.

The computer-readable medium 1025 interrelates structurally and functionally to the computer device 1005. The computer-readable medium 1025 stores, encodes, records, and/or embodies functional descriptive material. By way of illustration, the functional descriptive material may include computer programs, computer code, computer applications, and/or information structures (e.g., data structures or file systems). When stored, encoded, recorded, and/or embodied by the computer-readable medium 1025, the functional descriptive material imparts functionality. The functional descriptive material interrelates to the computer-readable medium 1025.

Information structures within the functional descriptive material define structural and functional interrelations between the information structures and the computer-readable medium 1025 and/or other aspects of the system 1000. These interrelations permit the realization of the information structures' functionality. Moreover, within such functional descriptive material, computer programs define structural and functional interrelations between the computer programs and the computer-readable medium 1025 and other aspects of the system 1000. These interrelations permit the realization of the computer programs' functionality.

By way of illustration, the computer device 1005 reads, accesses, or copies functional descriptive material into a computer memory (not shown explicitly in FIG. 1) of the computer device 1005. The computer device 1005 performs operations in response to the material present in the computer memory. The computer device 1005 may perform the operations of processing a computer application that causes the computer device 1005 to perform additional operations. Accordingly, the functional descriptive material exhibits a functional interrelation with the way the computer device 1005 executes processes and performs operations.

Furthermore, the computer-readable medium 1025 constitutes an apparatus from which the computer device 1005 may access computer information, programs, code, and/or applications. The computer device 1005 may process the information, programs, code, and/or applications that cause the computer device 1005 to perform additional operations.

Note that one may implement the computer-readable medium 1025 in a variety of ways, as persons of ordinary skill in the art would understand. For example, memory within the computer device 1005 may constitute a computer-readable medium 1025, as desired. Alternatively, the computer-readable medium 1025 may include a set of associated, interrelated, or networked computer-readable media, for example, when the computer device 1005 receives the functional descriptive material from a network of computer devices or information-processing systems. Note that the computer device 1005 may receive the functional descriptive material from the computer-readable medium 1025, the network, or both, as desired.

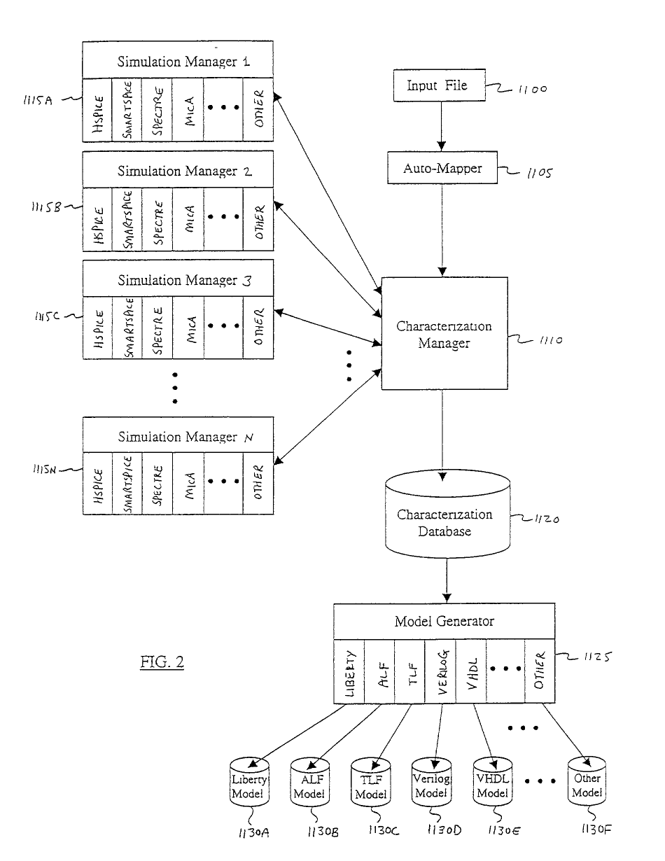

FIG. 2 shows a block diagram of the architectural process flow of a characterization tool that facilitates characterization of circuitry. More specifically, one may use the characterization tool that corresponds to FIG. 2 to generally characterize circuit or cell attributes, such as power consumption and timing. More particularly, one may use the characterization tool corresponding to FIG. 2 to characterize power and energy attributes of multiple power-supply circuits according to the invention.

The process flow in FIG. 2 includes using an input file 1100, an auto-mapper 1105, a characterization manager 1110 and associated simulation managers 1115A-1115N, a characterization database 1120, a model generator 1125, and model databases 1130A-1130F. The characterization tool may run or execute on a computer, such as the computer device 1005 in FIG. 1, or on a set or network of associated computers, as persons skilled in the art who have read the description of the invention would understand.

The characterization tool receives its input via an input file 1100. The input file 1100 contains a functional or behavioral specification of the circuitry or cell that the user wishes to characterize. The input file 1100 may include, for example, the input and output leads or pins of a cell, the relationship between the input and output leads or pins of the cell, and the functional description of the cell, as desired.

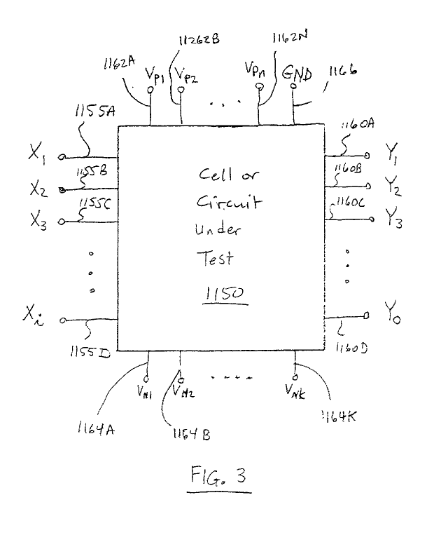

FIG. 3 shows a general block diagram of a cell or circuit under test 1150. The circuit 1150 may receive power from one or more positive power supplies or sources 1162A-1162N and one or more negative power supplies or sources 1164A-1164K, as desired. The circuit 1150 may also have a signal and/or power ground 1166. Generally speaking, depending on the actual circuitry, the circuit 1150 may have separate signal and power ground connections (not shown explicitly in FIG. 3), as desired.

Furthermore, the circuit The circuit 1150 may have one or more inputs and one or more outputs. The exemplary circuit 1150 in FIG. 3 has a number of inputs, generally designated as input X₁ 1155A, input X₂ 1155B, input X₃ 1155C, . . . and input Xᵢ 1155D. The circuit 1150 also has a number of outputs, generally designated as output Y₁ 1160A, output Y₂ 1160B, output Y₃ 1160C, . . . and output Y_{O} 1160D. Thus, the input file 1100 for circuit 1150 may describe the inputs X₁-Xᵢ, the outputs Y₁-Yₒ, the relationship between the inputs X₁ -Xᵢ and the outputs Y₁-Yₒ, and a functional description of the behavior of circuit 1150.

Referring to FIG. 2, the input file 1100 may provide the functional description of the cell or circuit in a variety of formats. For example, the input file 1100 may include a functional description of a cell in the form of the cell's Boolean specifications. The Boolean specifications may describe combinational or sequential circuits, as desired. The Liberty (.lib) models generated according to specifications from Synopsys, Incorporated (a vendor of EDA tools), constitute an example of a Boolean input file 1100.

Alternatively, the input file 1100 may include a functional description in a description language, for example, Pilot. Silicon Metrics Corporation, the assignee of this invention, provides the specifications for Pilot. Among other capabilities, Pilot allows the user to define cell characterization methodologies, cell behavior, and modeling properties, as desired.

Referring to FIG. 2, an auto-mapper 1105 receives the information in the input file 1100. The auto-mapper 1105 defines how the tool characterizes the cell. The auto-mapper 1105 processes the cell information within the input file 1100 and determines an appropriate methodology for characterizing the cell (unless the input file 1100 specifies a particular characterization methodology). Characterization methodology for a cell generally takes into account the cell's boundary network, e.g., the structure of the load circuitry applied to the cell's output or outputs and the structure of the source circuitry applied to the cell's input or inputs. The auto-mapper 1105 specifies the structure of the stimuli to apply to the input or inputs of the cell as well which output or outputs of the cell to observe. In other words, the auto-mapper 1105 uses the information in the input file 1100 to generate specifications for simulating the cell's behavior (as described below in more detail).

The auto-mapper 1105 provides those specifications to the characterization manager 1110. The specifications include a list of arcs for the characterization manager 1110 and the associated simulation managers 1115A-1115N to use to simulate the cell. An arc constitutes a measurement of a characteristic or characteristics of the effect of a change of state of an input to an output or an internal node of the cell. A change of state includes, for example, a transition from logic low to logic high, or vice-versa. The auto-mapper 1105 can consider a variety of attributes, as desired. Those attributes include, for example, propagation delay of the cell, the slew rate of the cell's output, the cell's input capacitance, and power consumption by the cell.

The auto-mapper 1105 provides the list of arcs by examining the cell's behavioral description. For combinational circuits, the auto-mapper 1105 may use an expression or equation that describes the cell's behavior (e.g., the Boolean expression for the cell) or the cell's truth table. For sequential circuits, the auto-mapper 1105 may use a cell's state table or an expression or set of expressions of the information that the state table contains. Using that information, the auto-mapper 1105 determines what changes in the state of an input or group of inputs of the cell propagate to an output or outputs of the cell and/or to an internal node or nodes of the cell. The auto-mapper 1105 determines the arcs that facilitate the characterization of various properties or constraints of a cell, for example, setup time, hold time, hidden power, switching power, minimum pulse-width of the clock signal, and the like.

Once it has determined the set of arcs, the auto-mapper 1105 specifies to the characterization manager 1110 the structure of the stimulus or stimuli that the characterization manager 1110 and the simulation managers 1115A-1115N use to simulate the cell's behavior. For example, the auto-mapper 1105 specifies the structure of the state transitions of the stimuli waveforms to apply to the cell in order to measure the cell's desired characteristics. The auto-mapper 1105 also selects a set of measurements of the various attributes of the cell (e.g., output voltage) that characterize the cell's behavior, and specifies the set of measurements to the characterization manager 1110.

Note that, rather than relying on the auto-mapper 1105 to provide a characterization methodology, the user may explicitly specify the methodology, as desired. The user may do so, for example, by using the Pilot language, as described above. In other words, the user may provide via Pilot a characterization methodology that overrides the characterization methodology that auto-mapper 1105 would have selected if the user had not chosen to specify a particular characterization methodology.

The characterization manager 1110 uses the information it receives from the auto-mapper 1105 to generate input files (not shown explicitly in FIG. 2) for the set of simulation managers 1115A-1115N. The input files constitute circuit representations of the circuit-under test or cell-under-test(CUT). The input files include descriptions of the components or devices within the cell, the cell's topology (i.e., the connections or couplings among the components or devices), the input stimuli, the types of simulation to perform and the parameters for those simulations, and the output or outputs to observe. In an exemplary embodiment of the invention, for each cell in a given circuit, a copy of the characterization manager 1110 runs on a computer device, such as computer device 1005 in FIG. 1. One, however, may use other arrangements for running the characterization manager 1110, as desired.

To achieve increased utility and flexibility, in exemplary embodiments the characterization manager 1110 provides the input files for a variety of simulators (used within the simulation managers 1115A-1115N) from a multitude of vendors. For example, the characterization manager 1110 may provide input files, sometimes referred to as “SPICE decks” or netlists, suitable for use with various simulators, for example, Star-HSPICE, SmartSPICE, Spectre, MICA, and the like. “SPICE” constitutes an acronym for Simulation Program with Integrated Circuit Emphasis, and refers to the generic version of a commonly used simulator familiar to persons of ordinary skill in the art. HSPICE (from Avant! Corp.), SmartSPICE (from Silvaco International), Spectre (from Cadence Design Systems, Inc.), and MICA (from Motorola, Inc.) refer to particular simulators. Note that, with modifications within the knowledge of persons of ordinary skill in the art, the characterization manager 1110 can generally provide input files for virtually any given simulators, as desired. The simulation managers 1115A-1115N use the input files they receive from the characterization manager 1110 to simulate the behavior of the circuit using a given simulator, for example, SPICE, HSPICE, SmartSPICE, Spectre, MICA, and the like.

The characterization manager 1110 employs a variety of techniques that tend to reduce the time and resources used during circuit characterization. Using those techniques, the characterization manager 1110 provides input files for the desired simulator or simulators. More specifically, the characterization manager 1110 employs a technique called auto-ranging to specify the range of values for the input stimulus or stimuli. The characterization manager 1110 specifies the range of values to the simulation managers 1115A-1115N.

The simulation managers 1115A-1115N use the range of values to simulate the behavior of the CUT and to generate response surfaces for the CUT. The response surfaces provide information about one parameter (e.g., delay through the CUT) as a function of other parameters (e.g., input transition delay and capacitive load). Commonly assigned U.S. patent application Ser. No. 09/090,457, titled “Method and System for Creating Electronic Circuitry,” and filed on Jun. 4, 1998, provides more details regarding the auto-ranging technique.

In exemplary embodiments of the invention, for each CUT, a separate copy of the characterization manager 1110 runs on one of an appropriate number, M, of coupled computer devices (such as computer device 1005 in FIG. 1). The number M constitute an integer equal to or greater than unity. Each of the characterization managers 1110 is responsible for the characterization of one of the CUTs. In other words, a library of cells that contains M cells causes the initiation of M characterization managers 1110. Note, however, that one may use other arrangements, for example, a single computer device, as desired. The choice of the number and configuration of the computer devices, as well as the structure and operation of the couplings among those computer devices (e.g., a network) depends on a number of considerations specific to each implementation, as persons of ordinary skill in the art would understand.

To characterize a CUT, in exemplary embodiments each characterization manager 1110 spawns or runs a set of N processes, where N constitutes an integer equal to or greater than unity. Each of the N processes corresponds to one of the simulation managers 1115A-1115N. Note, however, that one may use other arrangements for the simulation managers 1115A-1115N, depending on various factors (e.g., the speed, traffic level, and implementation of the coupling among the computer devices as well as the number of the computer devices), as persons of ordinary skill in the art would understand. Each of the simulation managers 1115A-1115N performs a simulation on the CUT using an input file that the characterization manager 1110 provides, as described above. Each of the simulation managers 1115A-1115N provides the results of the simulation to the characterization manager 1110.

Once it receives the simulation results from the simulation managers 1115A-1115N, each characterization manager 1110 determines the response surface or surfaces of the corresponding CUT. The characterization manager 1110 does so by causing the simulation managers 1115A-1115N to take a sufficiently large number of measurements of the CUT's simulated characteristics to represent the response with a desired degree of accuracy. In other words, the characterization manager 1110 uses a technique called over-sampling to determine the points that tend to increase the accuracy of the representation of the response surfaces of the CUT. For more details regarding the over-sampling technique, see U.S. Patent Application Ser. No. 09/090,457, cited and discussed above.

The characterization manager 1110 processes the results of the simulations that the simulation managers 1115A-1115N perform and makes the results available in a characterization database 1120. Thus, the characterization database 1120 includes characterization results for the cells in the design. A model generator 1125 uses the data residing within the characterization database 1120 to generate models (e.g., timing or power models) for the cells within the circuit. The models that the model generator 1125 produces serve as input files to simulation engines or simulators (not shown explicitly in FIG. 2).

The model generator 1125 may use properties that relate to the characteristics of the cells. The user may specify those properties in the input file 1100, as desired. The model generator 1125 may also use a technique known as data reduction to reduce the amount of data that represent the characteristics of the CUTs, as desired. The data-reduction technique allows the model generator to reduce the size of tables that represent the response surfaces of the CUTs. For more details regarding the data-reduction technique, see U.S. patent application Ser. No. 09/090,457, cited and discussed above.

To provide the tool with increased utility and flexibility, in exemplary embodiments of the invention the model generator 1125 generates models, such as timing or power models, in a variety of formats . For example, the model generator can generate models in the following formats: Liberty (from Synopsys, Incorporated), Advanced Library Format or ALF (from Nippon Electric Corporation), Timing Library Format or TLF (from Cadence Design Systems, Inc.), Verilog (also from Cadence Design Systems, Inc.), and/or Very High-Speed Integrated Circuit (VHSIC) Hardware Description Language or VHDL. The model generator 1125 may generate models for other simulators or simulation engines, as persons of ordinary skill in the art who have read the description of the invention would understand.

Moreover, the model generator 1125 may generate models in a parallel fashion, as desired. In other words, several instances of the model generator 1125 may run on a number of associated computer devices to generate the model databases 1130A-1130F. In such an implementation, each instance of the model generator 1125 receives the data within the characterization database 1120 and uses those data to generate a model or models for desired simulation engine or engines. The model generator 1125 stores the resulting models in model databases, as described above. The choice of the particular implementation of the model generator or generators 1125 depends on a number of considerations (e.g., amount and type of computing and networking resources, the complexity of the design, and the like), as persons of ordinary skill in the art understand.

The model generator 1125 provides the desired models in model databases 1130A-1130F. Note that the characterization tool can provide support for a variety of simulators, as desired. The model generator 1125 may provide models for additional simulators to other model databases, as denoted by model database 1130F in FIG. 2. A simulator may subsequently use a model from the appropriate model database to perform simulation of part or all of the circuit that contains the CUTs. From the results of the simulation run or runs, the user may obtain a desired characterization of the circuit.

The characterization tool may also perform checks to determine the relative accuracy of the results of the simulators. In other words, the tool may receive the results of the simulations from the simulators and compare those results to the results stored in the characterization database 1120. The comparison of the results allows the tool to gauge the accuracy of the models compared to the circuit-level models (e.g., SPICE models) that the simulation managers 1115A-1115N use.

Power and Energy Characterization

As noted above, one may use the tool described in connection with FIGS. 1 and 2 to perform a variety of circuit characterizations. One type of circuit or cell characterization involves energy or power characterization. Generally, the instantaneous power delivered to or delivered by a circuit or cell depends on the current, i(t), delivered to or delivered by the cell or circuit, and the voltage, v(t), across the terminals into which or from which the current flows. One may represent instantaneous power, p(t), as

p(t)=v(t)·i(t) (Eq.1)

The energy delivered to or delivered by the cell or circuit between an initial time t_{O} and a time t obtains from integrating the instantaneous power:

E=∫₀p(t)dt+E(t₀), (Eq.2A)

or

E=∫₀v(t)i(t)dt+E(t₀), (Eq.2B)

where E(t₀) represents the energy at time t₀. Where initial energy equals zero (i.e., E(t₀) =0), one may re-write Eq. 2A as:

E=∫₀p(t)dt, (Eq.2C)

or

E=∫₀v(t)i(t)dt, (Eq.2D)

In other words,

$$p ( t ) = \frac{d E ( t )}{d t} = {lim}_{Δt \to 0} \frac{Δ E ( t )}{Δ t} . \qquad ( Eq . 3 )$$

Consequently, one may obtain the power from an energy determination, and vice-versa. To calculate power, one differentiates the energy with respect to time. Conversely, to calculate energy, one integrates power over the desired period of time. Thus, a circuit characterization system according to the invention, for example as shown in FIG. 2), may calculate or characterize the circuit's or cell's energy attributes and derive power characterizations or attributes from it, or vice-versa. Accordingly, references to power characterization in this description of the invention imply that one may also obtain an energy characterization as desired, and vice-versa.

One may also represent the current i(t) in terms of a charge, q(t), delivered to or delivered by the cell or circuit:

$$i ( t ) = \frac{d q ( t )}{d t} = {lim}_{Δt \to 0} \frac{Δ q ( t )}{Δ t} . \qquad ( Eq . 4 )$$

Thus, the total charge transferred obtains from

Q=∫₀i(t)dt+Q(t₀), (Eq.5A)

where Q(t₀) represents the charge at time t₀. If the initial charge equals zero (i.e., Q(t₀) =0), then Eq. 5A becomes:

Q=∫₀i(t)dt. (Eq.5B)

For a capacitor that has a capacitance C, the following relationships hold:

q(t)=Cv(t), (Eq.6)

$$i ( t ) = \frac{d q ( t )}{d t} = C \frac{d v ( t )}{d t} , \qquad ( Eq . 7 )$$

and

$$V = \frac{1}{C} {\int }_{0}^{t} i ( t ) ⅆ t + V ( {t}_{0} ) , \qquad ( Eq . \text{8A} )$$

where V(t₀) represents the voltage across the capacitor at time t₀. For V(t₀)=0, one may re-write Eq. 8A simply as:

$$V = \frac{1}{C} {\int }_{0}^{t} i ( t ) ⅆ t . \qquad ( Eq . \text{8B} )$$

Substituting Eq. 7 into Eq. 2B, one may obtain the energy delivered by or absorbed by the capacitor from

$$E = {\int }_{0}^{t} C v ( t ) \frac{ⅆ v ( t )}{ⅆ t} ⅆ t , \qquad ( Eq . \text{9A} )$$

or

$$E ( t ) - E ( {t}_{0} ) = \frac{1}{2} C \{ {[ v ( t ) ]}^{2} - {[ v ( {t}_{0} ) ]}^{2} \} . \qquad ( Eq . \text{9B} )$$

If the capacitor has zero energy at time t₀, then one may re-write Eq. 9B as

$$E = \frac{1}{2} C {V}^{2} . \qquad ( Eq . 10 )$$

Exemplary embodiments of the invention use the characterization systems shown in FIGS. 1 and 2 to apply the above concepts to characterize cell energy or power in multiple-power-supply circuits.

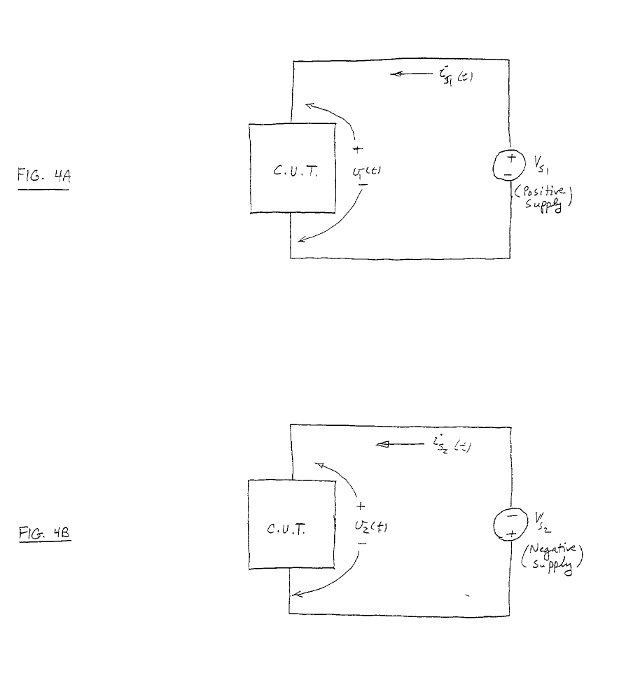

FIGS. 4A and 4B show sign conventions for characterizing power and energy. FIG. 4A shows a positive power source V_{S1}, in a circuit that includes to a cell-under-test (CUT). A current i_{S1}(t) flows in the circuit. The CUT has a voltage v₁(t) across it. The product of the signs of the voltage v₁(t) and the current i_{S1}(t) determines the direction of power flow between the voltage source and the CUT. For example, if the voltage v₁(t) has a positive value and the current i_{S1}(t) has a positive value, the CUT absorbs power from the power source V_{S1}. If v₁(t) has a positive value, but i_{S1}(t) has a negative value, the voltage source V_{S1} , absorbs power from the CUT.

FIG. 4B shows a power source V_{S2} coupled in a circuit to a circuit or cell under test (CUT). Unlike the voltage source V_{S1} in FIG. 4A, voltage source V_{S2} has a negative voltage value. A current i_{S2}(t) flows in the circuit. Similar to FIG. 4A, the CUT has a voltage v₂(t) across it. The product of the signs of the voltage v₂(t) and the current i_{S2}(t) determines the direction of power flow between the voltage source and the CUT. For example, if the voltage v₂(t) has a negative value and the current i_{S2}(t) has a negative value, the CUT absorbs power from the power source V_{S2}. If v₂(t) has a negative value, but i_{S2}(t) has a positive value, the voltage source V_{S2}absorbs power from the CUT.

Note that the conventions described above merely constitute a convenient way of determining the direction of the flow of power and energy. Rather than using the conventions described above, one may use other conventions and still employ the inventive concepts equally effectively, as persons of ordinary skill in the art would understand.

Power (or energy) characteristics of an arbitrary cell or circuit may include several types of power, such as internal power, hidden power, switching power, and leakage power. Internal power refers to the consumption of power within a cell in response to a change of state on one or more inputs of the cell. Hidden power refers to certain cases of internal power. Hidden power concerns power consumption within a cell in response to a change of state on one or more inputs that causes no corresponding change of state on any of the cell's outputs. Switching power, also known as capacitive or output power, concerns the consumption of power to charge and discharge an effective load capacitance at an output of the cell. Leakage power, also known as static power, refers to power consumption in a cell even when no inputs or outputs of the cell change state. Leakage power arises from deviations of actual circuitry from its ideal behavior. Leakage power typically results from sub-threshold leakage and current flow through reverse-biased junctions between diffusion regions and the substrate in an integrated circuit device.

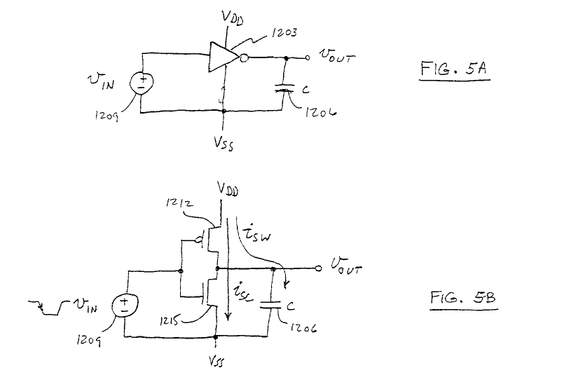

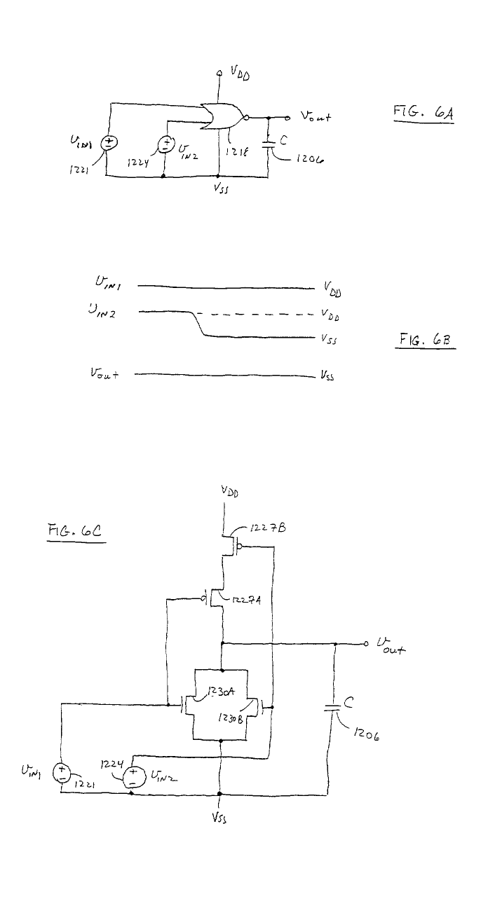

FIGS. 5 and 6 help to describe the various power or energy characteristics. FIG. 5A shows a circuit that includes an inverter 1203, powered from V_{DD} and V_{SS} rails. The inverter 1203 drives a load capacitor 1206. An input voltage 1209 drives the input of the inverter 1203. As FIG. 5B shows, the inverter 1203 includes a P-type transistor 1212 and an N-type transistor 1215. Consider the case where the input voltage 1209 is in a logic-high state. Transistor 1212 is in the OFF state and transistor 1215 is in the ON state. Thus, any charge on load capacitor 1206 discharges to V_{SS} via transistor 1215.

The circuit subsequently occupies a static state, where the input voltage 1209 and the output voltage of inverter 1203 remain substantially unchanged as a function of time (assuming constant supply voltages). Although transistor 1212 is in the OFF state, it conducts some relatively small amount of sub-threshold leakage current. The leakage current passes through transistor 1215 to V_{SS}. The leakage current contributes to the leakage power component of the inverter 1203.

Now, suppose that the input voltage 1209 of the inverter 1203 makes a transition from logic high to logic low. As the input voltage 1209 makes its transition, transistor 1212 begins to turn ON, while transistor 1215 begins to turn OFF. Because of their practical, non-ideal nature, the transistors 1212 and 1215 take a some amount of time to switch their respective states. As a result, some typically short interval of time exists during which both transistors 1212 and 1215 conduct current. As a result, a short-circuit current i_{SC} passes from V_{DD} through transistors 1212 and 1215 to Vss. The short-circuit current contributes to the internal power component of the inverter 1203.

Furthermore, in response to the high-to-low transition of its input voltage 1209, the output voltage of the inverter 1203 rises. As the output voltage of the inverter 1203 rises, it charges the load capacitor 1206. In other words, transistor 1215 turns OFF, while transistor 1212 turns ON and charges the load capacitor 1206 from V_{DD}. The charging current supplied to the load capacitor 1206 gives rise to switching power.

For an example of hidden power, consider the circuit shown in FIG. 6A. The circuit includes a two-input NOR gate 1218, powered from V_{DD} and V_{SS} rails. The NOR gate 1218 drives a load capacitor 1206. Input voltages 1221 and 1224 drive the two inputs of the NOR gate 1218, respectively. Suppose that, as FIG. 6B shows, the input voltage 1221 is at the logic-high level (V_{DD}), and that input voltage 1224 makes a high-to-low transition (i.e., from V_{DD} to V_{SS}). The output voltage of the NOR gate 1218, however, does not change, even though the transition at the input voltage 1224 causes the NOR gate 1218 to consume hidden power.

FIG . 6C s ho ws the details of NOR gate 1218. The NOR gate 1218 includes P-type transistors 1227A and 1227B, and N-type transistors 1230A and 1230B. Because input voltage 1221 is in the logic-high state, transistor 1227A is in the OFF state and transistor 1230A is in the ON state. Likewise, before its high-to-low transition, input voltage 1224 is in the logic-high state, thus turning OFF transistor 1227B and turning ON transistor 1230B. When the input voltage 1224 makes its high-to-low transition, transistor 1227B turns ON, while transistor 1230B turns OFF. The switching of states in transistors 1227B and 1230B consumes some power, even though the output of the NOR gate 1218 does not change state. Thus, the high-to-low transition on input voltage 1224 contributes to the hidden power component of NOR gate 1218.

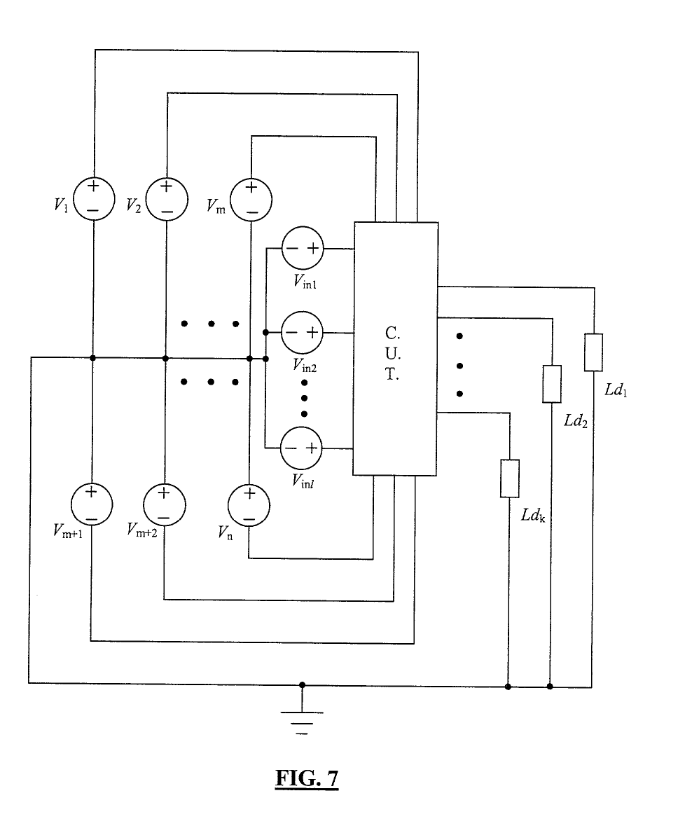

The circuits shown in FIGS. 5 and 6 each have a single power supply (denoted by the V_{DD}and V_{SS} rails). In general, a cell or circuit may receive its power or energy from multiple supplies. Furthermore, the cell or circuit may receive multiple input signals and drive multiple loads. FIG. 7 shows an example of a CUT that receives power from several power supplies. In particular, the CUT receives power from positive power supplies V₁, V₂, . . . , and Vₘ. The CUT also receives power from negative power supplies Vₘ₊₁, Vₘ₊₂, . . . , and Vₘ. Input sources Vᵢₙ₁, Vᵢₙ₂, . . . , and Vᵢₙₗ drive the CUT. The CUT drives loads Ld₁, Ld₂, . . . , and Ldₖ.

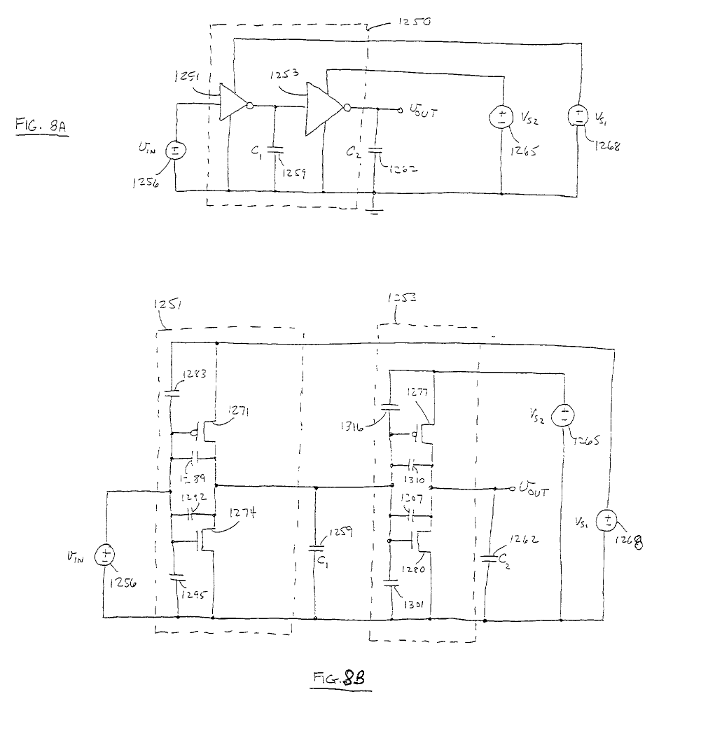

To determine the power or energy attributes of the CUT in FIG. 7, one may calculate the power or energy dissipated by or delivered by each of the components within the CUT. One may then add the individual power or energy components to arrive at the total power consumed by the CUT. The calculations for this approach, however, can become quite complex for even a simple circuit. For example, consider the circuit shown in FIG. 8. FIG. 8A illustrates a circuit that includes a CUT 1250. The CUT 1250 includes an inverter 1251 that drives a large driver inverter 1253. An input source vᵢₙ 1256 drives the inverter 1251. The CUT 1250 receives power from two power supplies Vₛ₁ 1265 and Vₛ₂ 1268. Capacitors C₁ 1259 and C₂ 1262 load inverters 1251 and 1253, respectively.

Suppose that one seeks to determine the power dissipated within each of the components in FIG. 8A. FIG. 8B shows more details of the circuit components within the inverters 1251 and 1253. Inverter 1251 includes transistor 1271 and associated parasitic capacitors 1283 and 1289. Inverter 1251 also includes transistor 1274 and associated parasitic capacitors 1292 and 1295. Similarly, inverter 1253 includes transistor 1277 and associated parasitic capacitors 1310 and 1316. Inverter 1253 also includes transistor 1280 and associated parasitic capacitors 1301 and 1307.

To calculate the power dissipated within the CUT 1250, one in turn has to calculate the power attributes (here, the power dissipated by) of each of the transistors 1271, 1274, 1277, and 1280, as well as the power attributes of the parasitic capacitors 1283, 1289, 1310, and 1316, and the load capacitors 1259 and 1262. One also has to calculate leakage power, short-circuit power, etc. Performing these calculations constitutes a relatively complex task. As a consequence, characterizing the power consumption of CUT 1250 becomes complicated and resource-intensive.

Characterization of power or energy of a multiple-power-supply cell according to the invention provides an alternative technique with less complexity compared to the approach described above. To characterize the power or dynamic energy attributes (i.e., power or dynamic energy dissipated by or delivered by) of a cell in a multiple-power-supply circuit according to the invention, one calculates the total dynamic energy or power provided by or consumed by the power supplies and subtracts from it the energy or power component of the load or loads. Also, one may account for the power or energy components of the input source or sources, as desired.

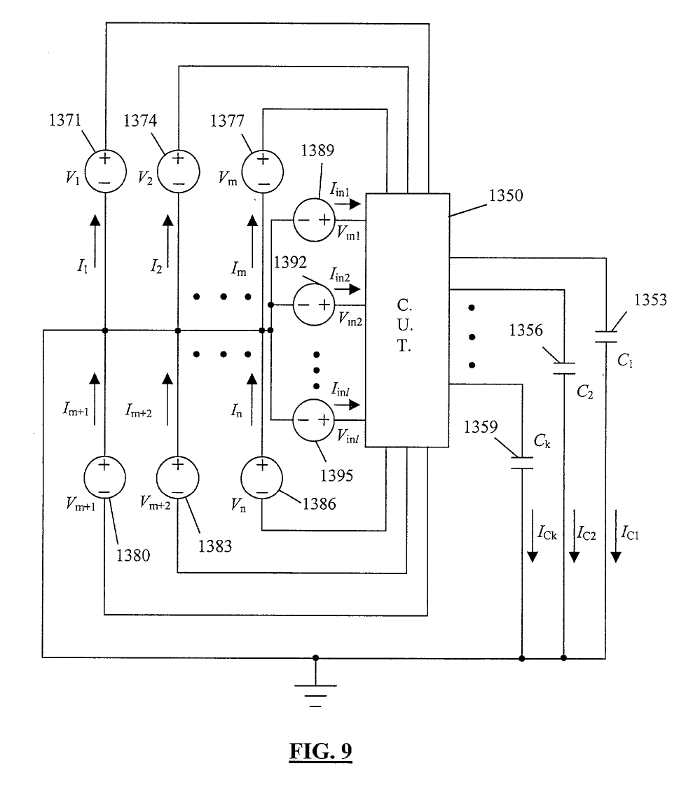

FIG. 9 shows a multiple-power-supply circuit for characterization according to the invention. The circuit includes a CUT 1350 and a plurality of power supplies 1371-1386. The power supplies include positive power supplies V₁ 1371, V₂ 1374, . . . , and Vₘ 1377, as well as negative power supplies Vₘ₊₁ 1380, Vₘ₊₂ 1383, . . . , and Vₙ 1386. One or more input sources may drive one or more inputs of the CUT 1350, respectively. FIG. 9 shows the input sources as voltage sources Vᵢₙ₁ 1389, Vᵢₙ₂ 1392, . . . , and Vᵢₙₗ 1395.

The CUT 1350 may drive one or more loads. FIG. 9 depicts the loads as capacitors C_{1 1353, C}₂ 1356, . . . , and Cₖ 1359. The load capacitors C₁ 1353, C₂ 1356, . . . , and Cₖ 1359 may include the load presented by a succeeding circuit or cell, and/or the interconnect capacitance. The interconnect capacitance represents the effective capacitance of an interconnect structure that couples to a respective output of the CUT 1350. As persons of ordinary skill in the art will understand, the loads in FIG. 9 (shown as load capacitors C₁ 1353, C₂ 1356, . . . , and Cₖ 1359) are substantially capacitive. In other words, they may include parasitic inductive or resistive elements but are mainly capacitive in nature.

The multiple-power-supply characterization of the CUT 1350 includes the determination of two attributes: (1) static power or energy (i.e., steady-state power or energy), and (2) dynamic energy, which estimates the energy flow between the power supplies and the CUT 1350 because of one or more changes of state at the inputs of the CUT 1350. For typical logic circuits, such as Complementary Metal Oxide Semiconductor (CMOS), the input sources 1389-1395 couple capacitively to the CUT 1350. In other words, the input sources 1389-1395 provide or consume relatively little static power (i.e., relatively little steady-state power dissipation). Also, the loads 1353-1359 constitute capacitors, i.e., the effective input-capacitance of the state or circuit following the CUT 1350.

Consequently, one may characterize static power or dynamic energy attributes by simply multiplying the DC current flowing from each power supply to the CUT 1350 by the respective power supply's voltage. Put another way, one may estimate the static power as:

$${P}_{S} = {\sum }_{n} {V}_{i} {I}_{i} , \qquad ( Eq . 11 )$$

where Pₛ constitutes the total static power, n represents the total number of power supplies 1371-1386, Vᵢ represents the voltage of the ith supply, and Iᵢ denotes the current flowing through the ith power supply (shown in FIG. 9 as I₁, I₂, and so on), respectively.

One may implement the characterization of the static power attribute in a variety of ways, as persons of ordinary skill in the art would understand. For example, one may use a zero-voltage power supply in series with each of the power supplies 1371-1386 to monitor the current flow through the respective power supply. As another example, depending on the particular simulator used, one may obtain from the simulator the current flowing through each of the power supplies 1371-1386.

To calculate the dynamic energy attribute of the CUT 1350, note that if a constant voltage source Vₓ delivers a charge Qₓ, then it delivers an energy equal to VₓQₓ. Thus, one may determine the dynamic energy attribute of the power supplies 1371-1386 as:

$${E}_{D} = {\sum }_{n} {V}_{i} {Q}_{i} , \qquad ( Eq . 12 )$$

where E_{D} constitutes the total dynamic energy, n represents the total number of power supplies 1371-1386, Vᵢ represents the voltage of the ith supply, and Qᵢ denotes, respectively, the charge that the ith power supply delivers or absorbs (depending on the details of the actual circuit the power supply or another part of the circuit may absorb or receive the charge).

As noted above, however, power characterization of multiple-power-supply cells according to the invention accounts for the power or energy attributable to the loads of the CUT 1350. If one or more input transitions causes one or more of the outputs of the CUT 1350 to make a transition, then energy may transfer between one or more of the power supplies 1371-1386 and one or more of the output load capacitors 1353-1359. To characterize the power or energy of the CUT 1350 according to the invention, one excludes the dynamic energy attribute of the load or loads.

To estimate the dynamic energy attributes of the load capacitors, consider a CMOS output stage that supplies energy to an output capacitor that has a capacitance C. A CMOS output stage generally includes a P-type network and an N-type network, similar to a CMOS inverter. Consider the case that the output network has supply voltages V_{DD} and V_{SS} of +V and zero volts, respectively, and that the output node makes a transition from zero to +V (a logic low-to-high transition). As described above, on a rising output swing from zero to +V, the capacitor absorbs energy equaling ½CV². The power supply (i.e., the source that has a voltage +V), however, expends an energy given by CV², or twice the energy that the capacitor C absorbs, to deliver a charge of CV to the capacitor. The P-network of the CMOS output stage dissipates the remaining energy, i.e., ½CV².

Now consider the case where the output node subsequently makes a transition from +V back to zero (a logic high-to-low transition). During this transition, the capacitor delivers its stored energy, ½CV², to the N-network of the output stage. The N-network of the output stage dissipates the stored energy that the capacitor delivers to it. Note that the power supply does not provide any energy during the transition from +V to zero volts.

Over the entire charge and discharge cycle (i.e., the low-to-high transition followed by the high-to-low transition) the power supply delivers an energy of CV². If the output node makes D transitions per second, the power supply delivers a dynamic energy ½CV²D. Put another way, f cycles of the output voltage cause the power supply to deliver an energy CV²f, where f=½D. Generally, a load capacitor that makes a voltage transition of ΔV at a rate of D transitions per second absorbs an amount of power ½CΔV²D or, alternatively, CΔV²f.

To account for the energy component because of the output capacitors, one subtracts from the overall dynamic energy attribute of the power supplies the dynamic energy attributes corresponding to the output capacitors. In other words, one subtracts from the overall dynamic attribute of the power supplies an amount of energy equaling ½CΔV² whenever the voltage across an output capacitor has a transition of ΔV during characterization. Thus, the dynamic energy attribute of the CUT 1350 becomes:

$${E}_{D} = {\sum }_{n} {V}_{i} {Q}_{i} - \frac{1}{2} {\sum }_{n} {C}_{i} Δ {V}_{i}^{2} , \qquad \text{(Eq. 13)}$$

where Cᵢ and ΔVᵢ represent the load capacitances and output voltage transitions, respectively.

Referring to FIG. 9, typically the energy attributable to the input sources 1389-1395 has a relatively small magnitude. Nevertheless, one may account separately for the energy attributable to the input sources 1389-1395, as desired. One may do so in a number of ways. As one alternative, one may account for the energy attributable to an input source, i.e., one of the sources 1389-1395, by monitoring the source's voltage and the current flowing from the source to the CUT 1350. One may then use Eqs. 1 and a2 above to estimate the energy attributable to that source. Using a similar procedure, one may determine the energy attributable to each of the input sources 1389-1395. One may subtract the energy attributable to each source from the energy calculated using Eq. 13 above to estimate a dynamic energy attribute of the CUT 1350 that accounts for the dynamic energy attributes of the input sources 1389-1395.

As a second alternative, one may estimate the amount of energy flow between each of the input sources 1389-1395 and the CUT 1350. One may then add the respective amounts of energy for all input sources 1389-1395 and subtract the total from the overall dynamic energy attribute of the input sources 1389-1395, as calculated by Eq. 13 above. To estimate the dynamic energy attribute of each of the input sources 1389-1395, one examines the circuitry at the input terminals of the CUT 1350. Knowing the characteristics of that circuitry enables one to estimate the dynamic energy attributes of the input circuitry during input signal transitions.

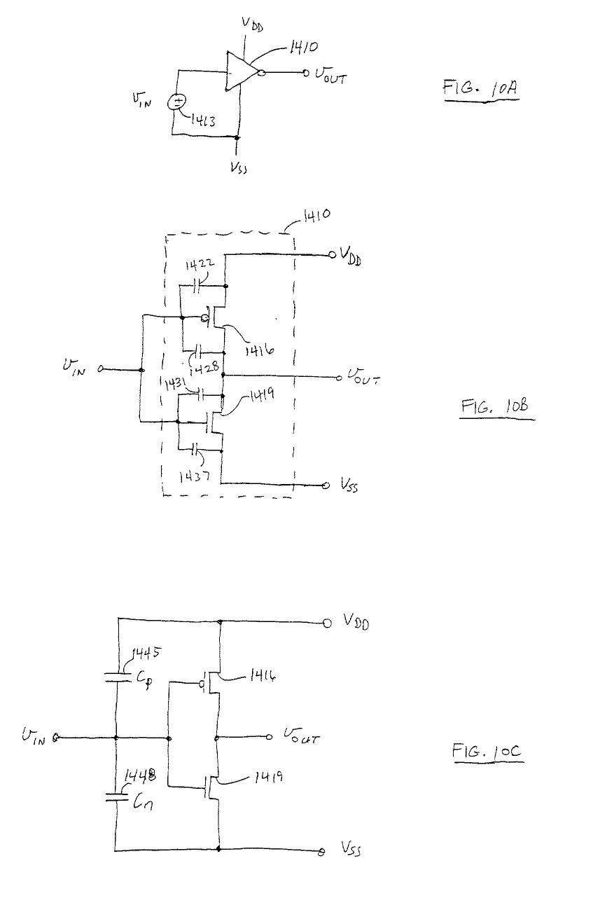

As an example, consider the input circuitry of a CUT 1350 built using CMOS technology. Typically, CMOS input circuitry includes a P-type network and an N-type network. FIG. 10 illustrates the input circuitry for an exemplary CMOS circuit. FIG. 10A shows a circuit that includes a CMOS inverter 1410. An input source 1413 drives the inverter 1410. FIG. 10B shows a more detailed diagram of the circuit in FIG. 10A. The inverter 1410 includes a P-type transistor 1416 and an N-type transistor 1419. Transistor 1416 has associated parasitic capacitors 1422 and 1428. Likewise, transistor 1419 has associated parasitic capacitors 1431 and 1437.

Note that, the parasitic capacitors 1422-1428 and 1431-1437 behave generally in a nonlinear manner in response to signals within the circuit, such as the gate-source voltage of the transistors 1416 or 1419. One, however, may model parasitic capacitors 1422-1428 and 1431-1437 as linear elements to simplify the characterization. An input signal transition causes transfer of energy to and from parasitic capacitors 1422-1428 and 1431-1437. One may estimate the dynamic energy attributable to the input source by calculating the amount of energy transferred to and from the parasitic capacitors 1422-1428 and 1431-1437.

FIG. 10C illustrates an equivalent circuit for the circuit shown in FIG. 10B. An equivalent capacitor Cₚ 1445 represents parasitic capacitors 1422-1428. Similarly, an equivalent capacitor C, 1448 represents parasitic capacitors 1431-1437. Note that, to further simplify the characterization, one may lump together capacitor Cₚ 1445 with capacitor Cₙ 1448 and represent them as a single capacitor, as desired.

On a falling input transition, the power supply delivers an amount of charge Qₚ. Of that charge, an amount of charge equal to C_{P}V_{DD} charges capacitor Cₚ. Typically, a calculation of the energy attributable to the output capacitance of a cell preceding the inverter 1410 accounts for the charge CₚV_{DD}. Thus, to avoid double-counting, one calculates Qₚ −CₚV_{DD} as the amount of charge delivered by the power supply taking into account the charge attributable to the input source during the falling transition. On a rising input transition, Cₚ discharges and delivers a charge of CₚV_{DD} to the power supply. For a rising input transition, one therefore calculates Qₚ +CₚV_{DD} as the amount of charge delivered by the power supply taking into account the charge attributable to the input source.

One calculates the ground current (or the current through a negative power supply, generally) in a similar manner. In other words, if a falling input transition causes a transfer of charge Qₙ in the ground line (or the negative power supply line, generally), one should compute Qₙ+CₙV_{DD}. Conversely, on a rising input transition, one should compute Qₙ−CₙV_{DD}.

During characterization, one often cannot accurately calculate the values of Cₚ and Cₙ for an arbitrary cell. One may compensate for the imperfect estimation of capacitance values in several ways. First, one may use imperfect estimates of the capacitance values. Any over-estimation or under-estimation of charge because of the imperfect capacitance values tend to cancel over complementary input transitions. For example, if one overestimates the charge on a rising input transition, one would under-estimate it by an equal amount on a successive falling input transition. For an even number of input transitions, the imperfect charge estimates cancel each other. Over a sufficiently large number of input transitions, the imperfect charge estimations would largely cancel each other.

As a second option, one may use an average of Qₚ and Qₙ. Assuming that Cₚ and Cₙ have equal values, one would calculate and use ½(Qₚ +Qₙ). This option provides improved accuracy for single input transitions and for a relatively small and odd number of transitions.

The circuit in FIG. 10 includes one power supply, V_{DD}. For a circuit that includes multiple power supplies, one may employ the techniques described above in connection with FIG. 10 to estimate the energy attributable to the input source or sources. Note that doing so in the multiple-power-supply scenario assumes that the positive supplies (e.g., power supplies 1371-1377 in FIG. 9) provide charge to the effective Cₚ capacitors, whereas the negative power supplies (e.g., power supplies 1380-1386 in FIG. 9) provide charge to the effective Cₙ capacitors.

For a multiple-power-supply circuit, one may use the imperfect charge estimates as described above. Note, however, that depending on the circuitry within the CUT (e.g., coupling capacitors and the like), the imperfect charge estimates may take a larger number of input transitions to cancel each other.

One may also use the charge-averaging technique described above in connection with FIG. 10, as follows. Assume that Qₚₒₛ, represents the net charge transferred between the positive power supplies (e.g., power supplies 1371-1377 in FIG. 9) and the CUT and the output capacitors. Assume further that Q_{neg} denotes the net charge transferred between the negative power supplies (e.g., power supplies 1380-1386 in FIG. 9) and the CUT and the output capacitors. Note that, but for the energy component because of the input source or sources, Qₚₒₛ would equal Q_{neg}. Assuming that Cₚ equals Cₙ, one may compute and use an average charge Q_{avg}:

$${Q}_{avg} = \frac{1}{2} ( {Q}_{pos} + {Q}_{neg} ) . \qquad \text{(Eq. 14)}$$

Assume that one defines two rations, Rₚₒₛ and R_{neg}, as follows:

$$\begin{matrix}{R}_{pos} = \frac{{Q}_{avg}}{{Q}_{pos}} , and & \text{(Eq. 15)} \\ {R}_{neg} = \frac{{Q}_{avg}}{{Q}_{neg}} . & \text{(Eq. 16)}\end{matrix}$$

In practice, Rₚₒₛ and R_{neg} should have values close to unity. One may use the values Rₚₒₛ and R_{neg} to scale the measured charge transfer for every power supply. In other words, one scales the charge transfer for the positive supplies (e.g., power supplies 1371-1377 in FIG. 9) by Rₚₒₛ. Likewise, one scales the charge transfer for the negative supplies (e.g., power supplies 1380-1386 in FIG. 9) by R_{neg}.

Thus, for an ith power supply, one obtains:

Q_{i′}=QᵢR, (Eq.17)

where Q_{i′} represents the scaled charge and R denotes a scaling ratio. The scaling ratio R equals Rₚₒₛ for a positive power supply, whereas it equals R_{neg} for a negative power supply. To account for the energy attributable to both input sources and output capacitors, one may re-write Eq. 13as:

$${E}_{D} = {\sum }_{n} {V}_{i} {Q}_{i}^{′} - \frac{1}{2} {\sum }_{n} {C}_{i} Δ {V}_{1}^{2} . \qquad \text{(Eq. 18)}$$

Alternatively, one may write E_{D} as:

$${E}_{D} = {\sum }_{n} {V}_{i} {Q}_{i} R - \frac{1}{2} {\sum }_{n} {C}_{i} Δ {V}_{i}^{2} . \qquad \text{(Eq. 19)}$$

The description of the invention included here provides illustrative embodiments of the inventive concepts. One may readily modify the described embodiments to produce alternative embodiments that nonetheless fall within the scope of the invention, as persons of ordinary skill in the art would understand. For example, referring to the drawings generally and, in particular FIG. 9, the power supplies 1371-1377 and 1380-1386 may include voltage sources, current sources, or a combination of voltage and current sources, as desired. Likewise, input sources 1389-1395 may include voltage sources, current sources, or a combination of voltage and current sources, as desired.

Furthermore, FIGS. 9 and 10 show capacitors as output loads. Note, however, that one may apply the inventive concepts described above to multiple-power-supply circuits that include other types or load by making modifications within the knowledge of persons skilled in the art. In other words, FIGS. 9 and 10 pertain to circuits implemented at least in part in CMOS technology. In general, however, one may apply power or dynamic energy characterization techniques and tools according to the invention to circuits designed in part or in whole in other technologies, as desired, by making appropriate modifications.

Exemplary embodiments of the invention use the circuit characterization systems shown in FIGS. 1 and 2 to perform power and/or energy characterization of multiple-power-supply circuits according to the invention. One, however, may use other suitable characterization systems to implement the inventive concepts, as desired.

During the characterization of multiple-power-supply circuits according to the invention, one simulates the power and/or energy attributes of the circuit that includes the CUT. At each step during the characterization where one performs circuit simulation, one may perform auxiliary measurements, for example, output transition time, slew rates, constraint characterization, and the like, as desired. Together with the characterization results according to the invention, the auxiliary measurements may provide the user with further information and insights regarding the circuit or cell under test. The user may use the characterization results, the auxiliary-measurements results, or both, to make decisions regarding a given design, as desired.

Further modifications and alternative embodiments of this invention will be apparent to persons skilled in the art in view of this description of the invention. Accordingly, this description teaches those skilled in the art the manner of carrying out the invention and are to be construed as illustrative only.

The forms of the invention shown and described should be taken as exemplary embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

We claim:

1. A system for characterizing multiple power-supply circuits, comprising:
a computer for characterizing energy attributes of a circuit that includes a cell, wherein the cell couples to a plurality of power supplies and has one or more outputs that drive, respectively, one or more loads, the computer configured to:
characterize, according to a model of an operation of the circuit, a dynamic energy attribute of each of the plurality of the power supplies;
characterize, according to the model of the operation of the circuit, a dynamic energy attribute of the one or more loads;
calculate an overall dynamic energy attribute for the plurality of power supplies by summing together the dynamic energy attributes of the plurality of the power supplies;
determine an overall dynamic energy attribute for the one or more loads by adding together the dynamic energy attributes of the one or more loads; and
compute a dynamic energy attribute of the cell by subtracting the overall dynamic energy attribute for the one or more loads from the overall dynamic energy attribute of the plurality of power supplies.

2. The system of claim 1, wherein the computer is further configured to characterize the dynamic energy attribute of each of the plurality of the power supplies by multiplying a voltage across the respective power supply by a charge flowing through the respective power supply.

3. The system of claim 2, wherein each of the one or more loads comprises a substantially capacitive load.

4. The system of claim 3, wherein each of the one or more loads comprises an effective input capacitance of a circuit coupled to the respective output of the cell.

5. The circuit characterization system of claim 4, wherein each of the one or more loads further comprises a capacitance of an interconnect structure coupled to the respective output of the cell.

6. The circuit characterization system of claim 5, wherein the computer is further configured to characterize the dynamic energy attribute of each of the one or more loads by multiplying one half of the respective capacitance of the load by a square of a voltage across the load.

7. The circuit characterization system of claim 6, wherein the computer is further configured to characterize the respective charge flow of each of the plurality of the power supplies by integrating with respect to time a current flowing through the power supply.

8. The circuit characterization system of claim 7, wherein the computer is further configured to characterize, according to a model of an operation of the circuit, a static power attribute of each of the plurality of power supplies by multiplying the current flowing through the respective power supply by the voltage across the respective power supply.

9. The circuit characterization system of claim 8, wherein the cell includes complementary metal oxide semiconductor circuitry.

10. The circuit characterization system of claim 8, wherein the circuit includes at least one positive power supply and at least one negative power supply.

11. A computer program product, comprising:
a computer application, adapted for processing by a computer to characterize energy attributes of a circuit that includes a cell, wherein the cell couples to a plurality of power supplies and has one or more outputs that drive, respectively, one or more loads, the computer application causing the computer to:
characterize, according to a model of an operation of the circuit, a dynamic energy attribute of each of the plurality of the power supplies;
characterize, according to the model of the operation of the circuit, a dynamic energy attribute of the one or more loads;
calculate an overall dynamic energy attribute for the plurality of power supplies by summing together the dynamic energy attributes of the plurality of the power supplies;
determine an overall dynamic energy attribute for the one or more loads by adding together the dynamic energy attributes of the one or more loads; and
compute a dynamic energy attribute of the cell by subtracting the overall dynamic energy attribute for the one or more loads from the overall dynamic energy attribute of the plurality of power supplies.

12. The computer program product of claim 11, wherein the computer application further causes the computer to characterize the dynamic energy attribute of each of the plurality of the power supplies by multiplying a voltage across the respective power supply by a charge flowing through the respective power supply.

13. The computer program product of claim 12, wherein each of the one or more loads comprises a substantially capacitive load.

14. The computer program product of claim 13, wherein each of the one or more loads comprises an effective input capacitance of a circuit coupled to the respective output of the cell.

15. The computer program product of claim 14, wherein each of the one or more loads further comprises a capacitance of an interconnect structure coupled to the respective output of the cell.

16. The computer program product of claim 15, wherein the computer application further causes the computer to characterize the dynamic energy attribute of each of the one or more loads by multiplying one half of the respective capacitance of the load by a square of a voltage across the load.

17. The computer program product of claim 16, wherein the computer application further causes the computer to characterize the respective charge flow of each of the plurality of the power supplies by integrating with respect to time a current flowing through the power supply.

18. The computer program product of claim 17, wherein the computer application further causes the computer to characterize, according to a model of an operation of the circuit, a static power attribute of each of the plurality of power supplies by multiplying the current flowing through the respective power supply by the voltage across the respective power supply.

19. The computer program product of claim 18, wherein the cell includes complementary metal oxide semiconductor circuitry.

20. The computer program product of claim 18, wherein the circuit includes at least one positive power supply and at least one negative power supply.

21. A method of characterizing a circuit that includes a cell, wherein the cell couples to a plurality of power supplies and has one or more outputs that drive, respectively, one or more loads, the method comprising:
characterizing, according to a model of an operation of the circuit, a dynamic energy attribute of each of the plurality of the power supplies;
characterizing, according to the model of the operation of the circuit, a dynamic energy attribute of the one or more loads;
calculating an overall dynamic energy attribute for the plurality of power supplies by summing together the dynamic energy attributes of the plurality of the power supplies;
determining an overall dynamic energy attribute for the one or more loads by adding together the dynamic energy attributes of the one or more loads; and
computing a dynamic energy attribute of the cell by subtracting the overall dynamic energy attribute for the one or more loads from the overall dynamic energy attribute of the plurality of power supplies.

22. The method of claim 21, wherein characterizing the dynamic energy attribute of each of the plurality of the power supplies comprises multiplying a voltage across the respective power supply by a charge flowing through the respective power supply.

23. The method of claim 22, wherein each of the one or more loads comprises a substantially capacitive load.

24. The method of claim 23, wherein each of the one or more loads comprises an effective input capacitance of a circuit coupled to the respective output of the cell.

25. The method of claim 24, wherein each of the one or more loads further comprises a capacitance of an interconnect structure coupled to the respective output of the cell.

26. The method of claim 25, wherein characterizing the dynamic energy attribute of each of the one or more loads comprises multiplying one half of the respective capacitance of the load by a square of a voltage across the load.

27. The method of claim 26, wherein characterizing the respective charge flow of each of the plurality of the power supplies comprises integrating with respect to time a current flowing through the power supply.

28. The method of claim 27, which further includes characterizing, according to a model of an operation of the circuit, a static power attribute of each of the plurality of power supplies by multiplying the current flowing through the respective power supply by the voltage across the respective power supply.

29. The method of claim 28, wherein the cell includes complementary metal oxide semiconductor circuitry.

30. The method of claim 28, wherein the circuit includes at least one positive power supply and at least one negative power supply.
